(19) United States
(12) Patent Application Publication
(10) Pub. No.: US 2010/0199171 A1
(43) Pub. Date: Aug. 5, 2010

(54) METHOD, SYSTEM AND PROGRAM PRODUCT FOR PROVIDING AN ON-DEMAND RICH MEDIA PRESENTATION TOOL

(75) Inventor: Michael Grosso, Coxsackie, NY (US)

Correspondence Address: HOFFMAN WARNICK LLC, 75 STATE STREET, 14TH FLOOR, ALBANY, NY, 12207, US

(73) Assignee: KINETICAST, INC., Coxsackie, NY (US)

(21) Appl. No.: 12/701,221

(22) Filed: Feb. 5, 2010

Related U.S. Application Data
(60) Provisional application No. 61/150,166, filed on Feb. 5, 2009.
(60) Provisional application No. 61/150,162, filed on Feb. 5, 2009.

(51) Int. Cl. G06F 3/14

(52) U.S. Cl. 715/234

(57) ABSTRACT

An on-demand rich media presentation tool (ODRMPT) is disclosed that allows users to upload files, author a presentation with rich media content, deliver it to recipients and track viewing data. The tracked viewing data can include information about recipients' behavior regarding the presentation, e.g., if the presentation was viewed, how long it was viewed, how long a recipient spent viewing each page, whether the presentation was forwarded, whether a recipient viewed a video and how much of the video was viewed, and where the recipient was located when viewing the presentation.

The current application claims the benefit of co-pending U.S. Provisional Application No. 61/150,162 titled “Method For Providing An On-Demand Rich Media Presentation Tool” and Application No. 61/150,166 titled “System and Program Product For Providing An On-Demand Rich Media Presentation Tool” both which were filed on 5 Feb. 2009, and both which are hereby incorporated by reference.

### TECHNICAL FIELD

This disclosure relates generally to online presentation tools and more particularly to a method, system and program product for providing an on-demand rich media presentation tool.

### BACKGROUND

Currently, in order to communicate presentations to prospective customers, partners or clients, a user is limited to traditional presentation tools. For example, one can create a presentation or document using a program such as PowerPoint®, Microsoft Word®, or Microsoft Excel® and attach that presentation or document to an email and send it to a recipient. (“PowerPoint”, “Microsoft Word” and “Microsoft Excel” are registered trademarks of Microsoft Corp.) The recipient then must download the attachment, and must further have installed the presentation program, such as PowerPoint, on their computer.

### SUMMARY

The inventor recognizes several disadvantages in conventional presentation tools, including the following:
A recipient may be reluctant to download an attachment for fear of viruses.
The presentation may actually contain a virus that would spread to the recipient's computer.
The recipient must have the third party presentation software, such as PowerPoint, installed on their computer.
The size of an attachment may either consume an excessive amount of the recipient's mailbox storage allotment, or there may be a size restriction on a recipient's firewall that would prevent the attachment from being received.
The creator and sender of the presentation cannot track the recipient's viewing information, for example, a creator/sender cannot track a recipient's viewing patterns, behavior or consequent information regarding geographic location, level of interest, time spent on each portion of a presentation, etc.

An on-demand rich media presentation tool (ODRMPT) is disclosed herein that allows users to upload files, author a presentation with rich media content, deliver it to recipients and track viewing data. The tool further allows a user to incorporate uploaded files, including but not limited to .pdf, .avi, .doc, .xls, .ppt, .jpeg, .mpeg, .bmp file types. The tracked viewing data can include information about recipients' behavior regarding the presentation, e.g., if the presentation was viewed, how long it was viewed, how long a recipient spent viewing each page, whether the presentation was forwarded, whether a recipient viewed a video and how much of the video was viewed, where the recipient was located when viewing the presentation, etc.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 depicts an illustrative computer system for implementing embodiment(s) of the present invention.

FIGS. 2-10 show exemplary screen shots of the platform provided by the system of the present invention to create, send and track an RMP according to embodiments of the invention.

FIG. 11 shows an exemplary screen shot of an email containing a link to a RMP according to embodiments of the invention of this disclosure.

FIG. 12 shows a screen shot of a sample RMP according to embodiments of the invention of this disclosure.

FIGS. 13 and 14 show exemplary screen shots of some of the tracking and analytic tools available to a user when creating and delivering a RMP according to embodiments of the invention of this disclosure.

FIG. 15 shows an exemplary screenshot showing options to allow a user to follow-up on sent RMPs.

It is noted that the drawings of the disclosure are not to scale. The drawings are intended to depict only typical aspects of the disclosure, and therefore should not be considered as limiting the scope of the disclosure.

### DETAILED DESCRIPTION

An on-demand rich media presentation tool (ODRMPT) is disclosed that allows a user to upload files, author rich media presentations (RMPs) that incorporate rich media including, but not limited to, video, audio, graphics, text, web links, previously uploaded files and documents, send it to recipients and track viewing behavior and information.

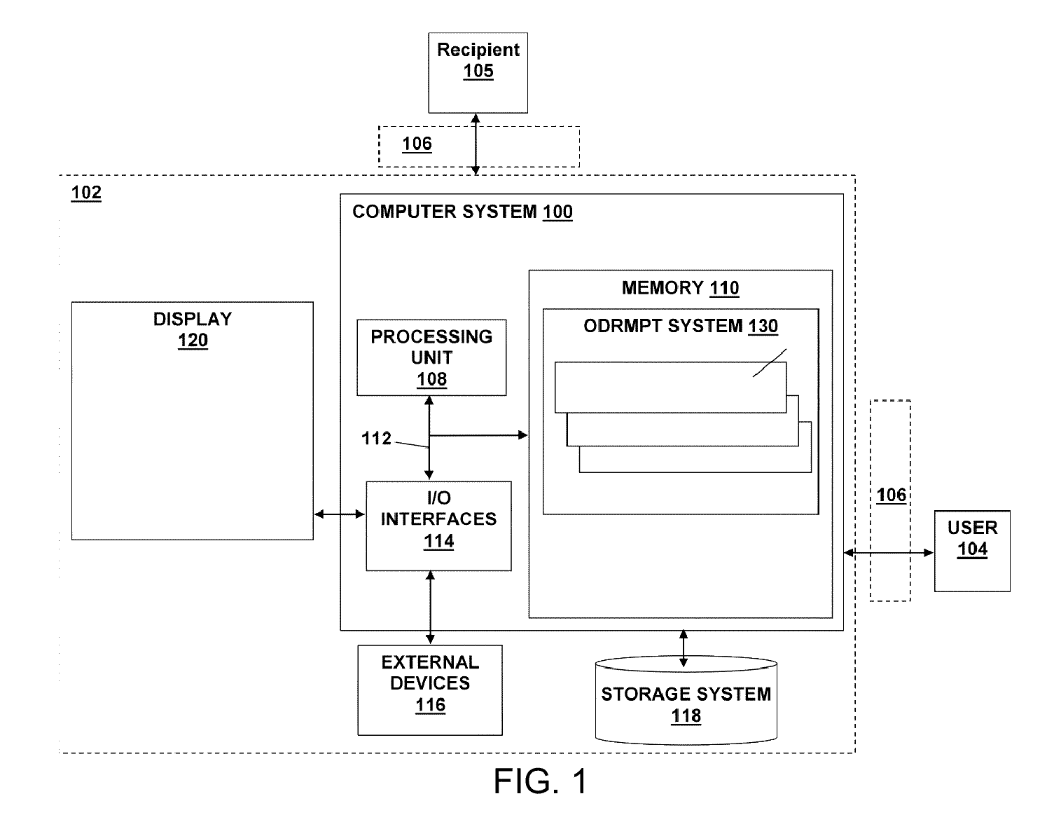

To this extent, FIG. 1 shows an illustrative environment 102 for providing an ODRMPT tool according to an embodiment. Environment 102 includes a computer system 100 that can perform a process described herein in order to provide an ODRMPT tool. In particular, computer system 100 is shown including an ODRMPT program 130, which makes computer system 100 operable to provide an ODRMPT tool by performing a process described herein.

Computer system 100 is shown including a processing component 108 (e.g., one or more processors), a storage component 110 (e.g., a storage hierarchy), an input/output (I/O) component 114 (e.g., one or more I/O interfaces and/or devices), and a communications pathway 112. Further, computer system 100 is shown in communication with external devices/resources 116 and one or more storage systems 118. In general, processing component 108 executes program code, such as ODRMPT program 130, which is at least partially fixed in storage component 110 and/or storage system(s) 118. While executing program code, processing component 108 can process data, which can result in reading and/or writing transformed data from/to storage component(s) 110, 118 and/or I/O component 114 for further processing. Pathway 112 provides a communications link between each of the components in computer system 100. I/O component 114 can comprise one or more human I/O devices, which enable a human user 104 to interact with computer system 100 and/or one or more communications devices to enable a system user 104 to communicate with computer system 100 using any type of communications link. External devices/resources 116 can comprise any devices (e.g., keyboard, pointing device, display (e.g., display 120, printer, etc.) that enable a user to interact with computer system 100 and/or any devices (e.g., network card, modem, etc.) that enable computer system 100 to communicate with one or more other computing devices. To this extent, ODRMPT program 130 can manage a set of interfaces (e.g., graphical user interface(s), application program interface, and/or the like) that enable human and/or system users 104 to interact with ODRMPT program 130. Further, ODRMPT program 130 can manage (e.g., store, retrieve, create, manipulate, organize, present, etc.) the data using any solution.

In any event, computer system 100 can comprise one or more general purpose computing articles of manufacture (e.g., computing devices) capable of executing program code, such as ODRMPT program 130, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, ODRMPT program 130 can be embodied as any combination of system software and/or application software.

Further, ODRMPT program 130 can be implemented using a set of modules 132. In this case, a module 132 can enable computer system 100 to perform a set of tasks used by ODRMPT program 130, and can be separately developed and/or implemented apart from other portions of ODRMPT program 130. As used herein, the term “component” means any configuration of hardware, with or without software, which implements the actions described in conjunction therewith using any solution, while the term “module” means program code that enables a computer system 100, such as a general purpose computing device, to implement the actions described in conjunction therewith using any solution. When fixed in a storage component 110 of a computer system 100 that includes a processing component 108, a module is a substantial portion of a component that implements the actions. Regardless, it is understood that two or more components, modules, and/or systems may share some/all of their respective hardware and/or software. Further, it is understood that some of the functionality discussed herein may not be implemented or additional functionality may be included as part of computer system 100.

When computer system 100 comprises multiple computing devices, each computing device can have only a portion of ODRMPT program 130 fixed thereon (e.g., one or more modules 132). However, it is understood that computer system 100 and ODRMPT program 130 are only representative of various possible equivalent computer systems that may perform a process described herein. To this extent, in other embodiments, the functionality provided by computer system 100 and ODRMPT program 130 can be at least partially implemented by one or more computing devices that include any combination of general and/or specific purpose hardware with or without program code. In each embodiment, the hardware and program code, if included, can be created using standard engineering and programming techniques, respectively. Regardless, when computer system 100 includes multiple computing devices, the computing devices can communicate over any type of communications link. Further, while performing a process described herein, computer system 100 can communicate with one or more other computer systems, such as a system user 108, using any type of communications link. In either case, the communications link can comprise any combination of various types of wired and/or wireless links; comprise any combination of one or more types of networks; and/or utilize any combination of various types of transmission techniques and protocols.

Computer system 100 represents any type of computer system capable of carrying out the teachings of the present invention. For example, computer system 100 can be a laptop computer, a desktop computer, a workstation, a handheld device, a server, a cluster of computers, etc. In addition, as will be further described below, computer system 100 can be deployed and/or operated by a service provider that provides an ODRMPT in accordance with the present invention. It should be appreciated that a user 104 and a recipient 105 can access computer system 100 directly, or can operate a computer system that communicates with computer system 100 over a network 106 (e.g., the Internet, a wide area network (WAN), a local area network (LAN), a virtual private network (VPN), etc). In the case of the latter, communications between computer system 100 and a user-operated computer system can occur via any combination of various types of communications links. For example, the communication links can comprise addressable connections that can utilize any combination of wired and/or wireless transmission methods. Where communications occur via the Internet, connectivity can be provided by conventional TCP/IP sockets-based protocol, and an Internet service provider can be used to establish connectivity to the Internet.

Computer infrastructure 102 is only illustrative of various types of computer infrastructures that can be used to implement the present invention. For example, in one embodiment, computer infrastructure 102 can comprise two or more computing devices (e.g., a server cluster) that communicate over a network (e.g., network 106) to perform the various process steps of the invention. Moreover, computer system 100 is only representative of the many types of computer systems that can be used in the practice of the present invention, each of which can include numerous combinations of hardware/software. For example, processing unit 108 can comprise a single processing unit, or can be distributed across one or more processing units in one or more locations, e.g., on a client and server. Similarly, memory 110 and/or storage system(s) 118 can comprise any combination of various types of data storage and/or transmission media that reside at one or more physical locations. Further, I/O interfaces 114 can comprise any system for exchanging information with one or more external devices/resources 116. Still further, it is understood that one or more additional components (e.g., system software, communication systems, cache memory, etc.) not shown in FIG. 1 can be included in computer system 100. However, if computer system 100 comprises a handheld device or the like, it is understood that one or more external devices/resources 116 (e.g., a display) and/or one or more storage system(s) 118 can be contained within computer system 100, and not externally as shown.

Storage system(s) 118 can be any type of system (e.g., a database) capable of providing storage for information under the present invention. To this extent, storage system(s) 118 can include one or more storage devices, such as a magnetic disk drive or an optical disk drive. In another embodiment, storage system(s) 118 can include data distributed across, for example, a local area network (LAN), wide area network (WAN) or a storage area network (SAN) (not shown). Moreover, although not shown, computer systems operated by user 104 can contain computerized components similar to those described above with regard to computer system 100.

### Creating a Rich Media Presentation

Computer system 100 provides a platform for a user to create a rich media presentation (RMP) by accessing the internet and logging into the ODRMPT. The platform can be offered according to the Software as a Service (SaaS) model and as such a user may connect to a remote server to access the program. Other configurations for providing the tool of the present disclosure are also possible, for example ODRMPT program 130 can be hosted locally on a user's computer, and/or provided through an internal intranet or direct connection.

When setting up an ODRMPT account, as users are added, computer system 100 allows a user to be designated as either having Read-Only, Write or Publishing privileges. For example, a user with Read-Only privileges can select pre-published presentation pages and assemble a presentation or can select pre-published RMP's and send them. A user with Read-Only privileges cannot create a RMP using the creation tools. A user with Write privileges has full access to all of the RMP creation tools. In addition to the privileges of a Write user, a user with Publishing privileges also has the ability to publish presentation pages and RMP's to other user accounts. Other users can then send the RMP's or use the presentation pages in assembling their own RMP. Users with Publishing privileges can also have the capability of revoking content that they previously published so that outdated content cannot be used.

Once a user accesses the ODRMPT, the ODRMPT allows the user to create an account with the ODRMPT. Once logged in, computer system 100 provides the user with access to content stored locally on their computer, and/or content previously uploaded to their account, in order to create their RMP. In this latter case, a user does not have to store documents and content on their local computer, enabling access to one's data wherever they access the ODRMPT, for example through an internet connection. For example, computer system 100 can allow a user to upload a document, e.g., a PowerPoint presentation, store it in the ODRMPT, and then later choose that document/presentation for inclusion in a RMP that they are creating. ODRMPT can also allow a user to create and store content, such as default text, hyperlinks, download buttons, images, videos and email messages that can be used and re-used in multiple RMP's, as well as shared with users within the same account in the ODRMPT. For example, a user can record a video or audio clip, using a camera/microphone, a web camera or other audio/visual equipment. The user can then play back the recorded audio clip or video, edit the audio clip or video, choose to re-record the audio clip or video and/or opt to share the audio clip or video with other users on the same ODRMPT account. If the content is shared, any user with the applicable permissions can access the shared document and can use it in their own RMPs.

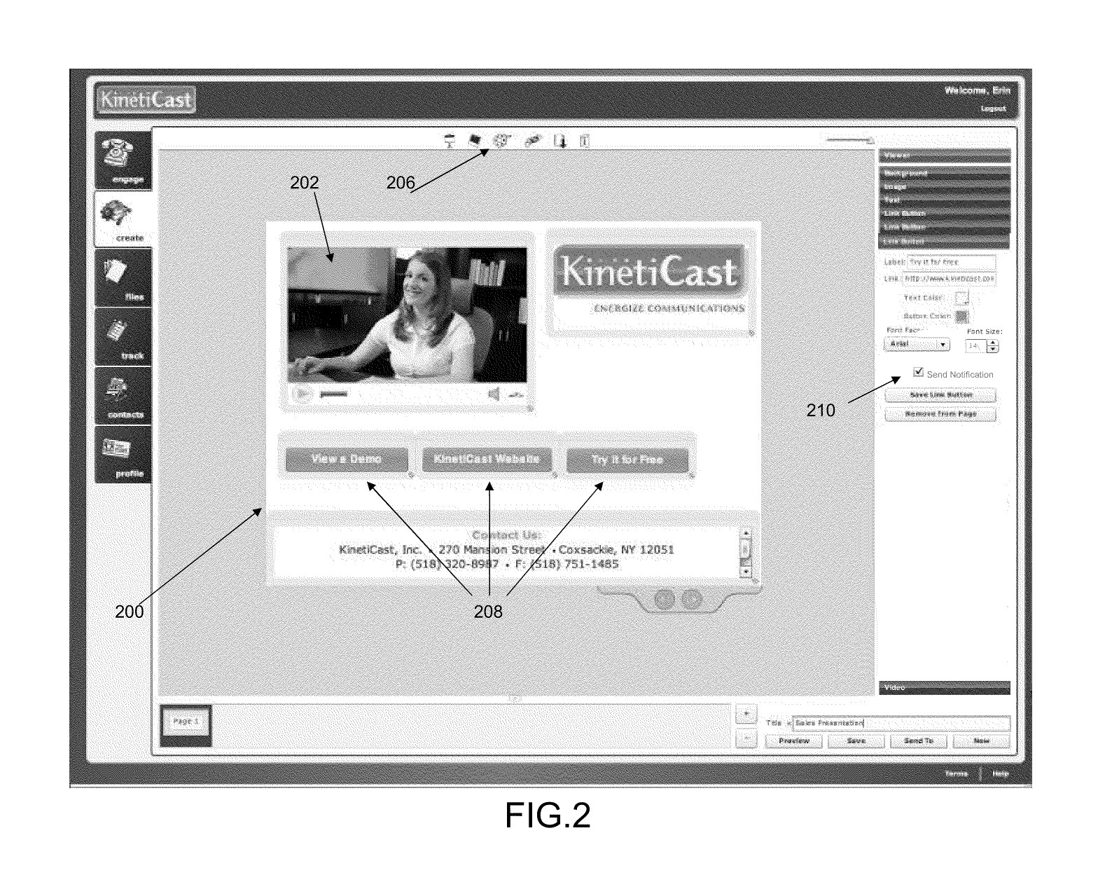

Turning to FIG. 2, an exemplary screen shot of the platform provided by computer system 100 is shown. For example, the ODRMPT provides the user with several tabs to manage, create, send and track their RMP. FIG. 2 shows an “Engage” tab, “Create” tab, “Files” tab, “Track” tab, “Contacts” tab and “Profile” tab.

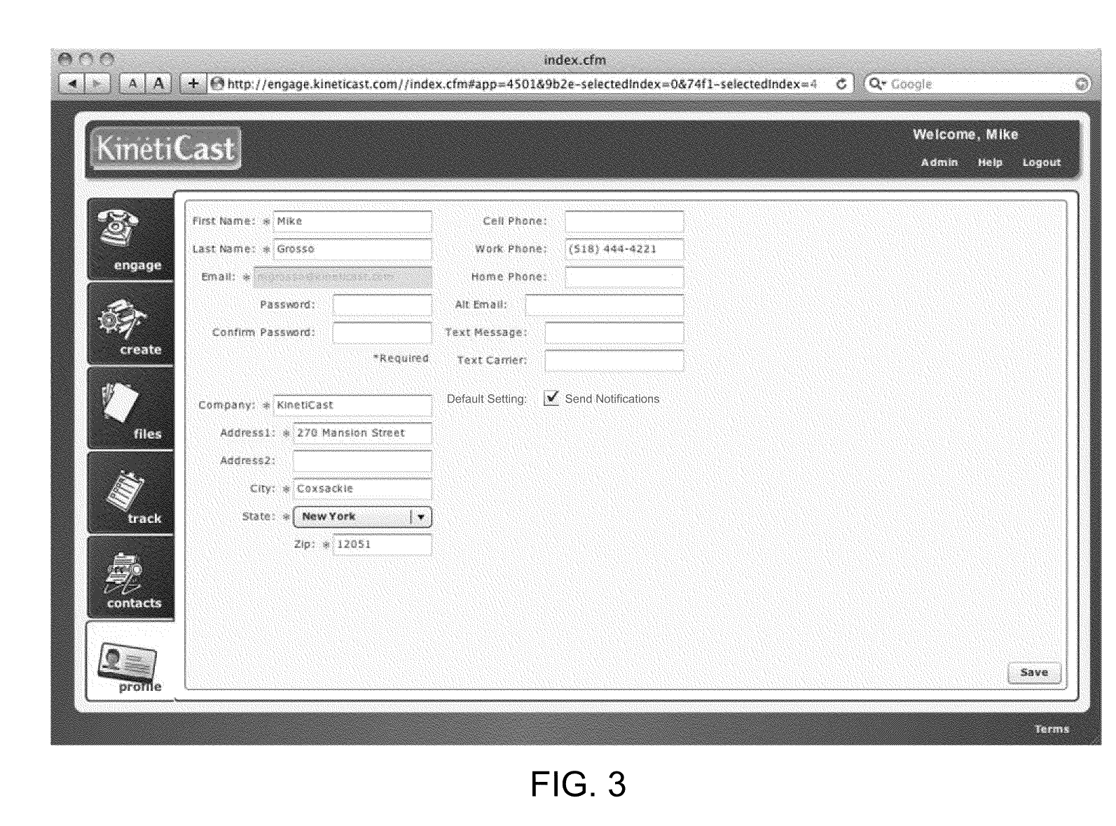

As shown in FIG. 3, under the “Profile” tab, a user can access their account and user information, such as name, email address, mailing address, phone numbers, etc. This information can be automatically included in a footer of an email from the user including the RMP, in order to comply with anti-spamming laws. Computer system 100 can also allow a user to manage his account, such as updating a user password, from the “Profile” tab.

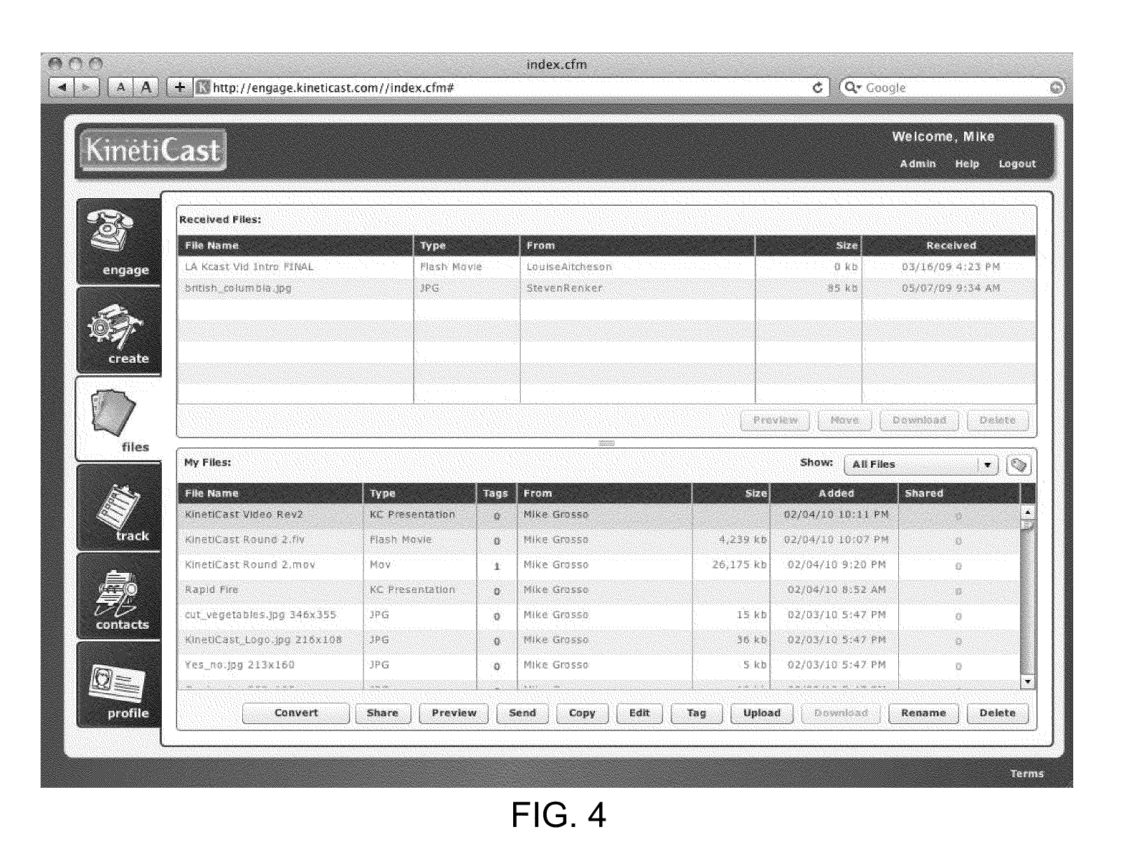

As shown in FIG. 4, under the “Files” tab, computer system 100 can provide a user with a list (e.g., called “My Files”) specific to that user, on the ODRMPT. Files uploaded by a user can be stored in the ODRMPT in a user's “My Files” list. A user can also add files to his/her “My Files” list by moving a file that has been shared by another user, or sent to the user by another user. ODRMPT allows a user to manage their “My Files” by renaming, deleting, uploading, downloading, sharing and previewing the files. The “My Files” can also include a column that indicates whether a file has been shared or sent to another user. The column can list various attributes about the files, for example, file name, sender, size, date added, and date shared. A user can organize their “My Files” by sorting by any of the columns. The ODRMPT can also provide document management capability, including functionality such as setting access to files (e.g., ‘no access’, ‘write access’ and ‘read only’) or setting revision controls.

As also shown in FIG. 4, computer system 100 can provide a user with another list (e.g., “Received Files”) specific to that user, on the ODRMPT. The “Received Files” lists files received from other users. Computer system 100 can also provide commonly shared space or directories to allow users to access documents based on permission rules. Computer system 100 can provide an inbox containing typical information regarding the files, for example, name, file type, sender, size and/or the date/time of when it was received. Computer system 100 further allows a user to manage their “Received Files” by downloading, deleting, moving and previewing. A user can move files from their Received Files to their “My Files” list. A user can organize their “Received Files” or “My Files” by sorting by any of the columns.

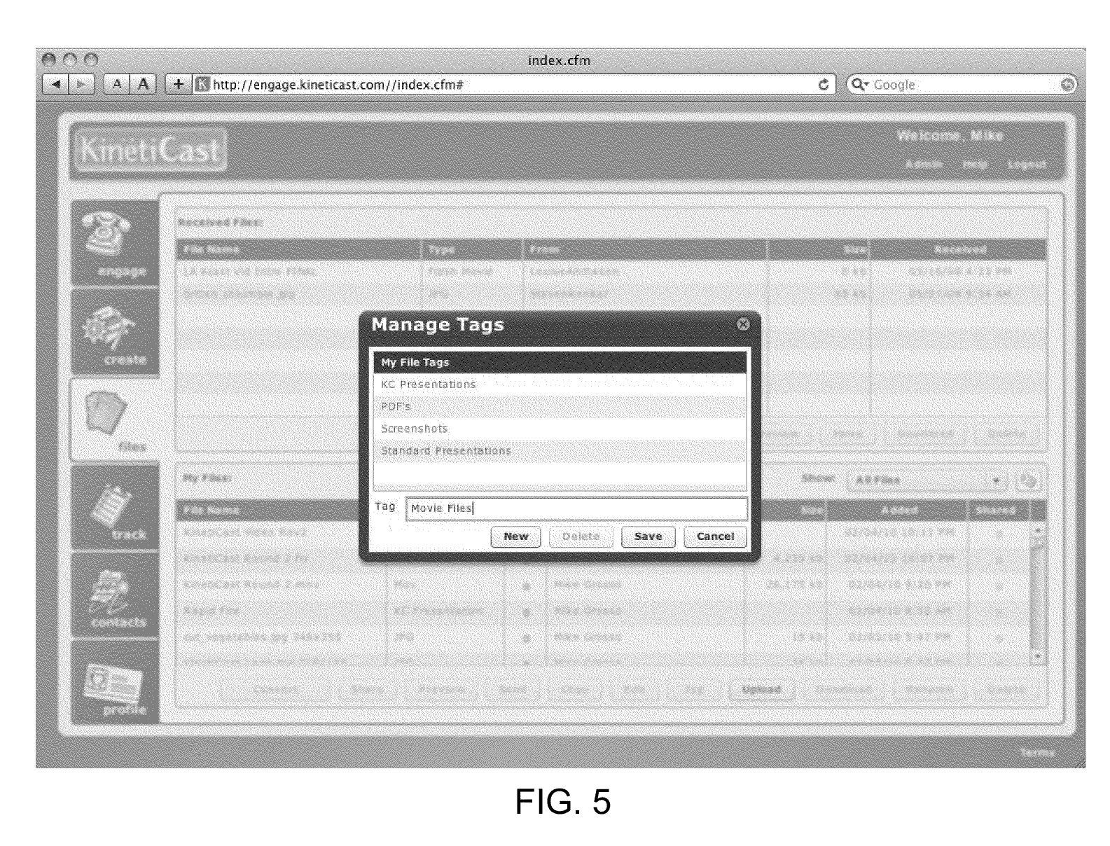

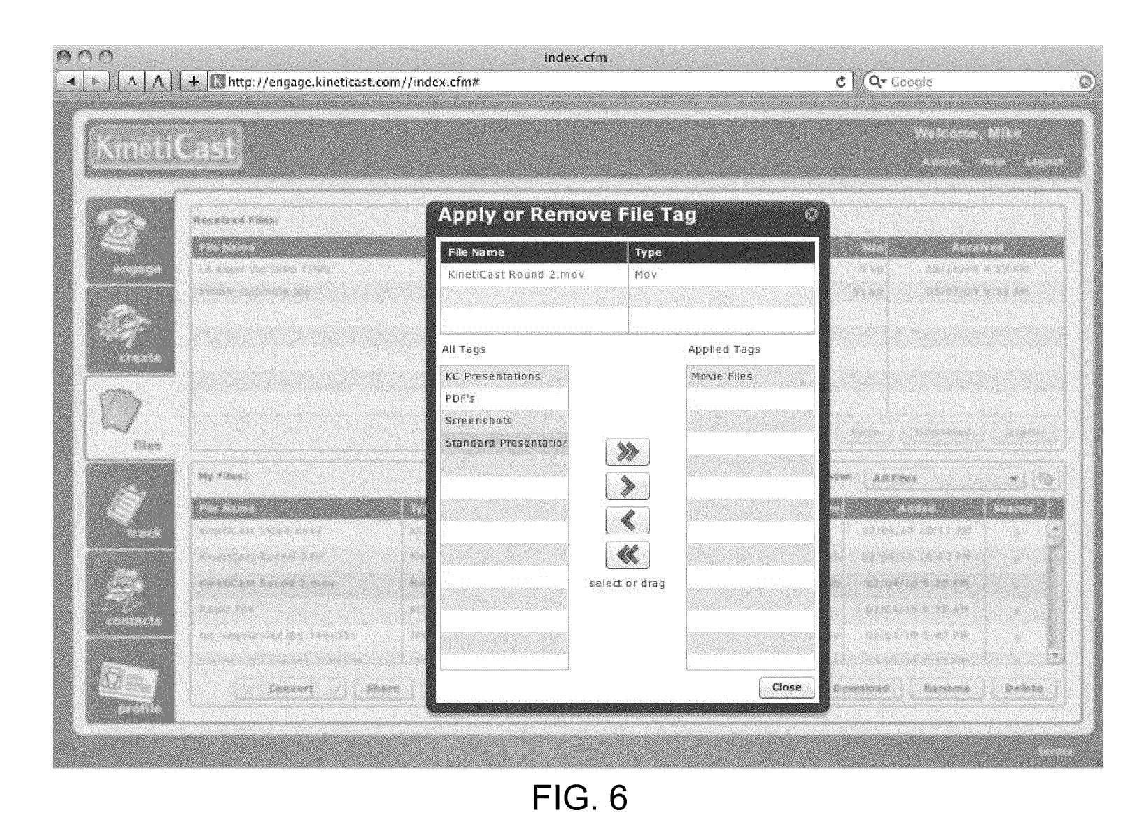

As shown in FIG. 5, computer system 100 can further provide “Tags” that a user can also apply to the files. “Tags” are user-defined labels that can be applied to files, contacts and/or tracked presentations to better organize them. Files and contacts may have multiple “Tags.” FIG. 5 shows how a user can manage their tags, such as adding or deleting tags. FIG. 6 shows how a user can apply a tag to their files.

Turning back to FIG. 2, under the “Create” tab, in an embodiment, computer system 100 provides a user with the capability to create a single page or multi-page RMP and to customize the look of the RMPs. For example, a user can customize their RMP with their choice of content, including, but not limited to background images, text (font, color, size), pictures (e.g. .jpg, .gif, .png), third party presentation software (e.g., PowerPoint, Keynote), business documents, (e.g. .pdf, .doc, .xls), hyperlinks, download links, animations, videos, etc. A user can drag and drop the content to create their desired visual layout. For example, as illustrated in the exemplary RMP 200 shown in FIG. 2, a user could create their RMP to include a video screen 202 in the top left corner of the RMP, with their company logo on the top right corner, various promotional and marketing materials in the center of the RMP, and text containing contact information along the bottom of the RMP. FIG. 2 further shows icons 206 that allows a user to choose among the available options for customizing, including audio, video, links, text, etc.

Computer system 100 can provide the user with a preview of RMP 200, to see how it will look to someone who receives the RMP. Computer system 100 can allow a user to continue to edit RMP 200 until the user is satisfied with the content and look of RMP 200. For example, a user can select the size of the viewable area and can adjust their layout to fit different screen resolutions, e.g., 640×480, 800×600 or “sized to fit.” A user can also select the colors of the presentation slides as well as the color of the margins surrounding the slides. A user can also save a RMP so that it can be edited and sent to another contact if desired.

As shown in FIG. 2, computer system 100 can further allow a user to include links 208, or buttons, in the RMP which will allow a recipient to view and/or download a document or file. Since (as discussed below) only a link is sent to the recipient, large files are not sent directly to a recipient. Instead, the user can include one or more links 208 in RMP 200 which a recipient can click on to view and/or download a file. This can include any file type, such as audio, video, .xls, .doc, .pdf, .ppt, etc. When the recipient clicks on link 208, they can further be provided with a choice to just view the document, or download the document to their local computer.

As also shown in FIG. 2, computer system 100 further can provide a user to receive notifications regarding links 208 including in RMP 200. For example, when the user includes link 208 in RMP 200, the user can be provided with the option to set Receive Notifications 210 to yes or no. If Receive Notifications 210 is set to yes, then whenever a recipient clicks on link or button 208, the user receives a notification. The Notification can include, but is not limited to, such fields as Button or Link Name, Associated File Name, Associated File Extension, Recipient Information and Presentation Information. Recipient Information can include but is not limited to First Name, Last Name, Job Title, Company Name, Company URL, Phone Number, Extension, Cell Phone Number, and Notes. Presentation Information can include but is not limited to Presentation Title, Email Subject, Date Sent and Times Viewed and Pages of the RMP Viewed.

### Delivering a Rich Media Presentation

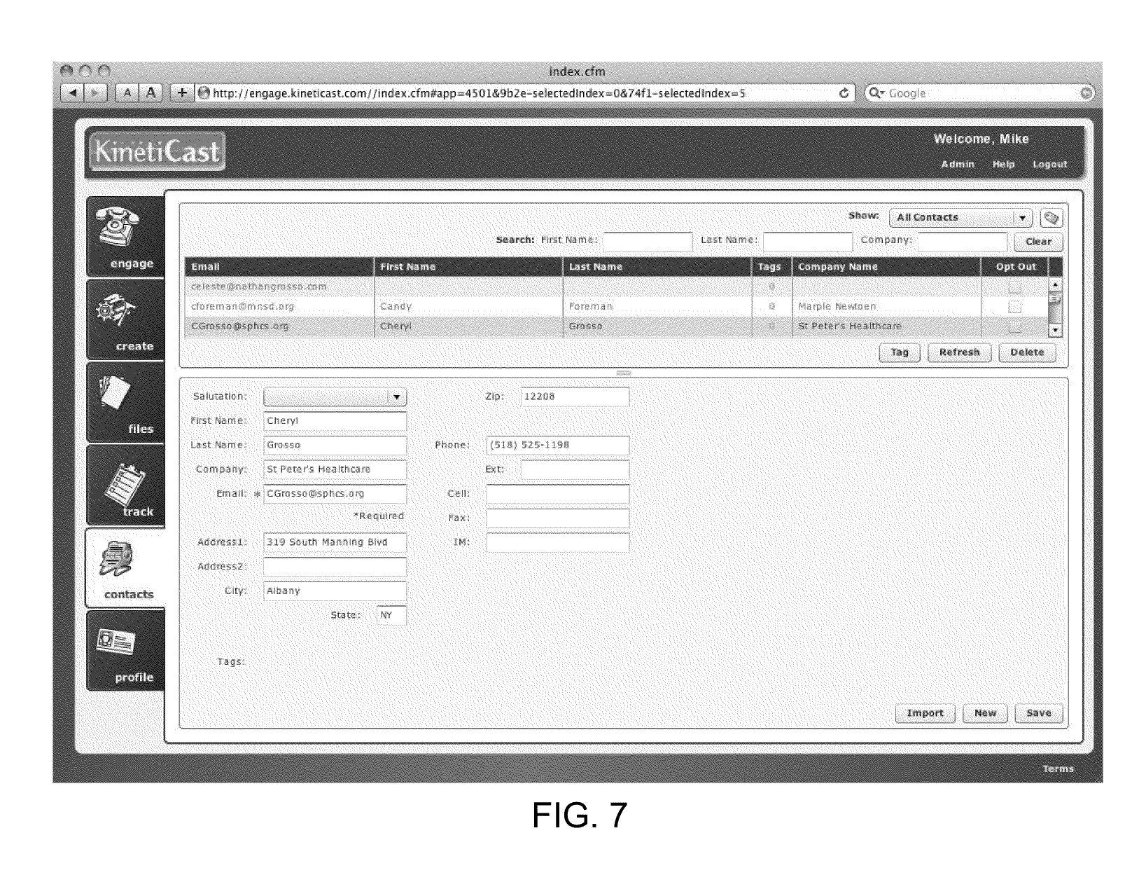

After a user has customized RMP 200, computer system 100 allows a user to decide to whom they are going to deliver RMP 200. For example, as shown in FIG. 7, under the “Contacts” tab, the ODRMPT can include a contact manager, which manages a user's list of contacts and their corresponding information. A user can fill in fields such as name, company, email address, phone numbers, fax numbers, business or home addresses, etc. The ODRMPT stores a user's contacts so when a user logs in, he/she can access their contact list and choose those contacts to whom they wish to send the RMP. If a user does not wish to fill out contact fields, they can also choose just to input the desired recipient's email address when sending the RMP. The ODRMPT will then save that email address in “Contacts” and will consequently be available to the user in the event that he/she wishes to send something in the future to that contact. A user can select a group of recipients or can select recipients individually. Computer system 100 further can import a user's contacts (e.g., from a CSV file) thus making it easy to import lists from other sources such as MS Outlook® or a Customer Relationship Management software product (CRM).

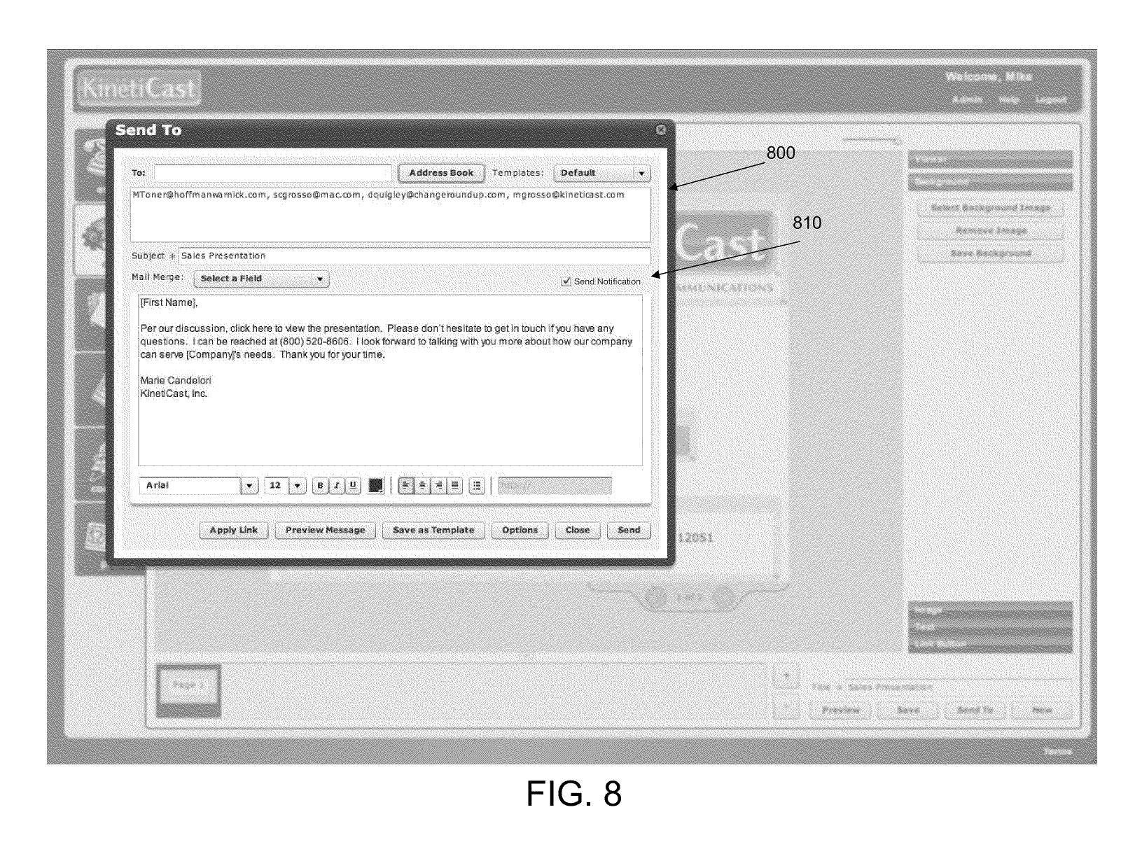

As shown in FIG. 8, computer system 100 can create an email 800 to the recipient which includes a link to the RMP. Computer system 100 allows a user to input recipient information (or choose from Contacts), include a customizable message in the body of email 800 or select an email template, and choose any text in the email that will be the clickable link to the RMP. Computer system 100 can further allow a user to select the font, size, color and alignment for the text of their message and can preview their message before sending it. Computer system 100 can further provide the user with the option to save any customized message as a template. When creating email 800, the user also has the ability to insert merge fields from Contacts into the email messages. Such merge fields include, but are not limited to, Contact Salutation, First Name, Last Name and Company.

Prior to sending email 800, the user has the option to set email 800 to Send Notifications. If Send Notifications 810 is set to yes, then whenever a recipient views RMP 200, the user receives a notification. The Notification can include, but is not limited to, such fields as First Name, Last Name, Job Title, Company Name, Company URL, Phone Number, Extension, Cell Phone Number, Notes, Presentation Title, Email Subject, Date Sent, Times Viewed and Pages of the RMP Viewed. The user can also save their preference as to whether Send Notifications should default to yes or no. Notification preferences can be set in the Profile screen, but can also be overridden when a user is on the send to screen.

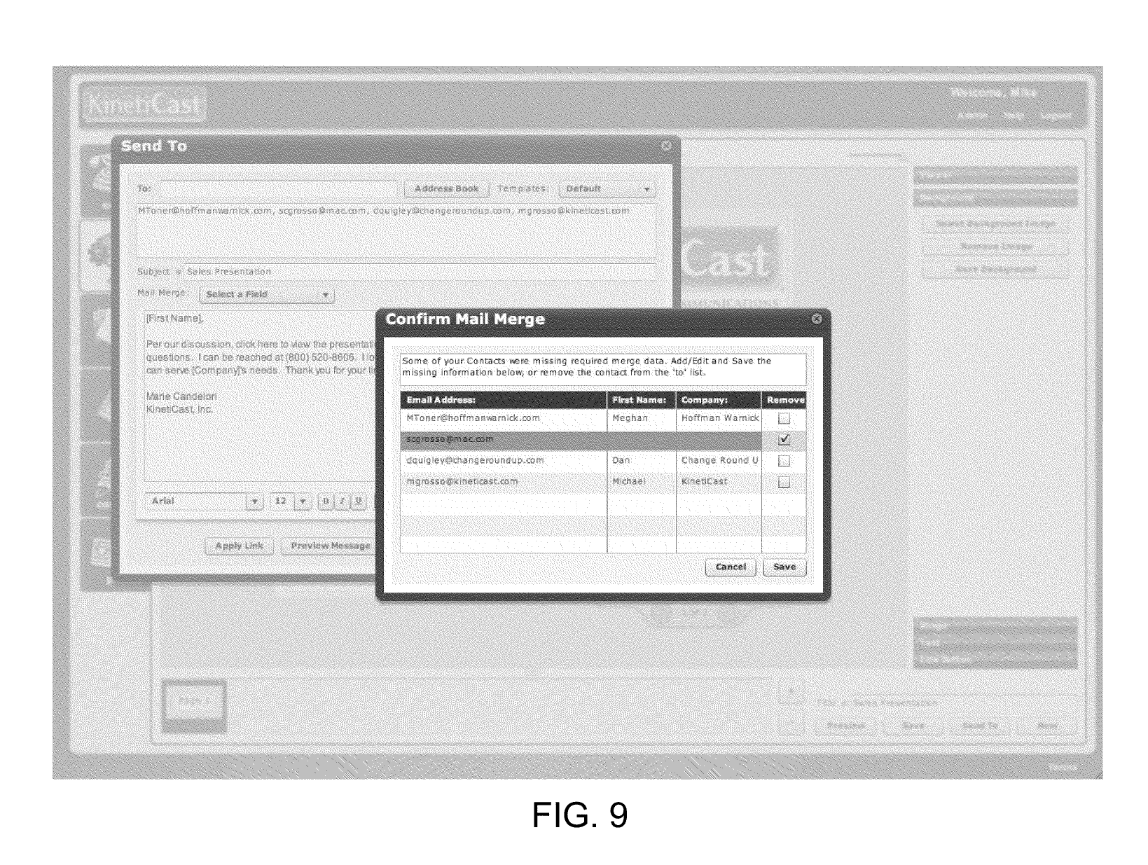

As shown in FIGS. 8 and 9, computer system 100 provides a user with a mail merge option. For example, when a user includes a merge field for a Contact that has a null value in any of the used merge fields, the user is prompted upon Preview and Send to either enter the required fields into the table or remove the recipient from the distribution list. If the user enters in any Contact data in the table shown in FIG. 9, that data is automatically saved in the Contacts. Consequently, should the user send a subsequent email to the same recipient using the same merge fields, the fields in question will no longer be null and the data previously entered in this table will populate.

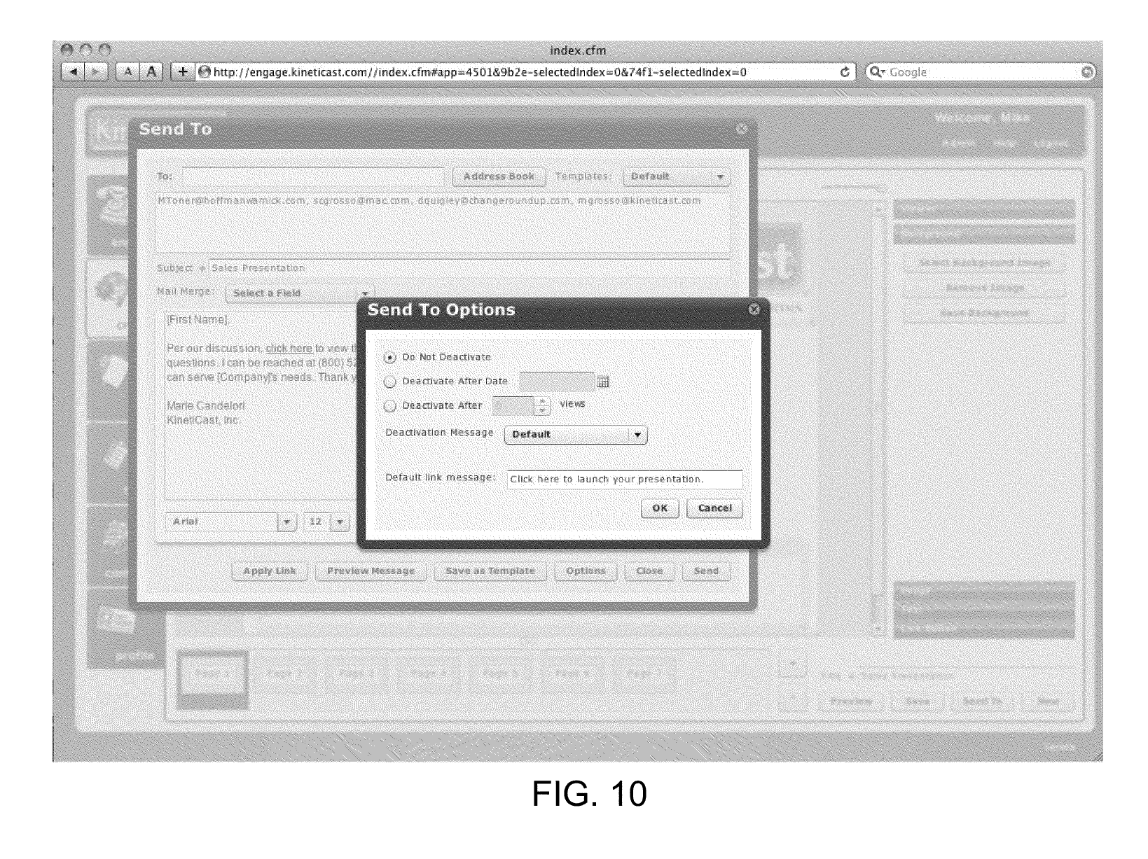

As shown in FIG. 10, computer system 100 further can provide a user with an option to decide whether he/she would like the recipient to be able to view the RMP an unlimited number of times, or whether they will be limited to a certain number of viewings. A user can also decide how long the RMP will be active, i.e., a user can indicate that after a week, the RMP will no longer be accessible from the ODRMPT, or after a certain number of views. When a RMP is inactive and the recipient tries to access it, they can receive a “deactivation message.” A user can select a custom “deactivation message.” For example, the user could set a simple message stating that the RMP is no longer active, or the user could set an updated or follow-up RMP as the “deactivation message” so that once the original RMP has been viewed the requisite number of times, the recipient will access the follow up or updated RMP using the original link. At any time, e.g. even after the email is sent to the recipient and the RMP is delivered, the user can opt to deactivate or reactivate the RMP and change the deactivation message.

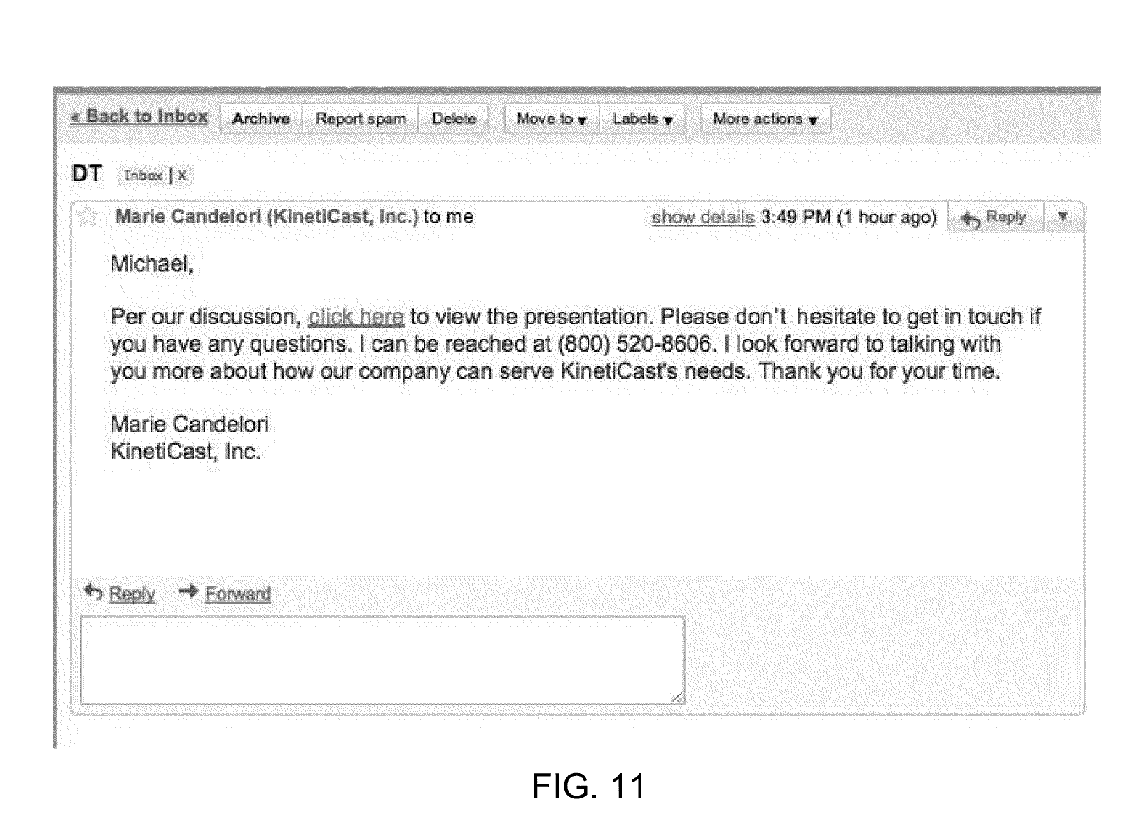

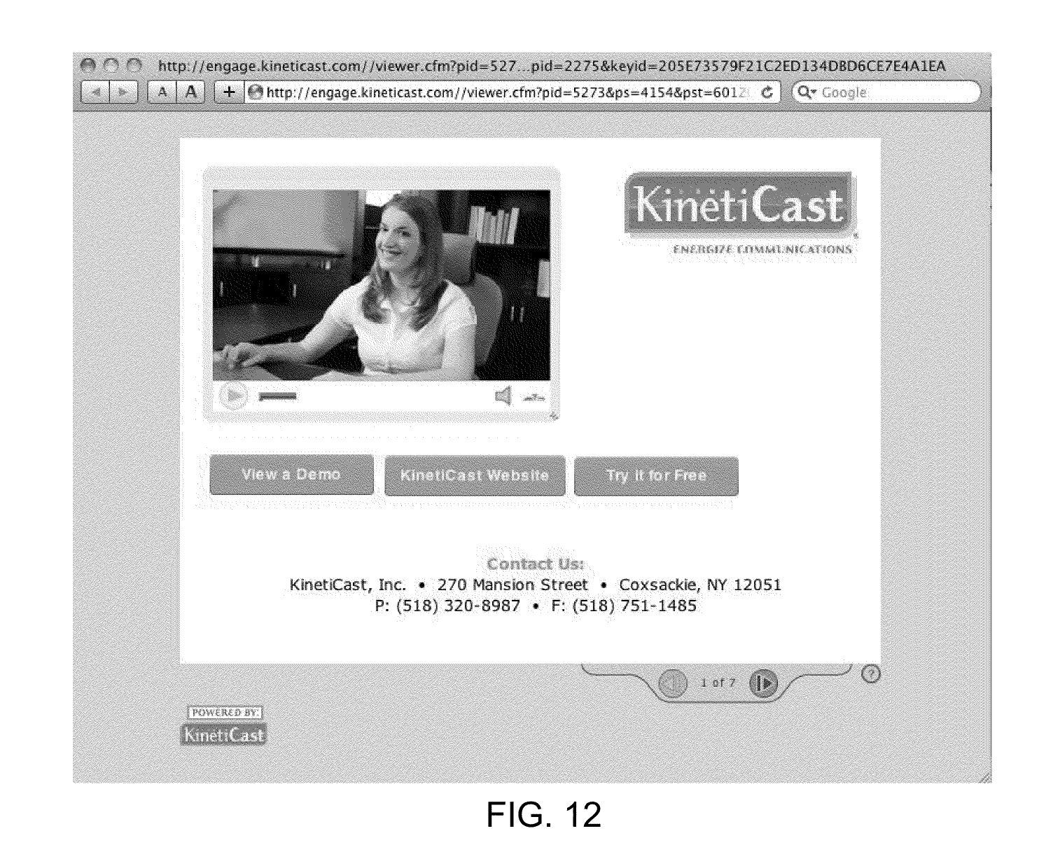

Once the user indicates which contacts, i.e., recipients, will receive the RMP, computer system 100 can send email 800 to each recipient. Email 800 contains a link to the RMP, which is stored on a server, e.g., a server hosted by the ODRMPT. The user can choose to set any text within the email as the link. An example of such an email 800 can be found in FIG. 11. In this way, the RMP itself is not sent to the recipient, just a link to access the RMP. For example, in FIG. 11, the recipient would click on the hypertext words “click here” to access the RMP. This will open up a browser on the recipient's computer where the recipient can view the RMP. FIG. 12 shows RMP 200 as it appears to a recipient in the recipient's browser. Computer system 100 allows a user to create an RMP with controls that can be controlled by a recipient to allow the recipient to proceed through the RMP at their own pace, i.e., a recipient can spend as much time as desired on each slide of the RMP. Computer system 100 can provide tracking and analytic information regarding this self-directed pace of the recipient, as will be discussed in more detail below. Computer system 100 can provide a notification to a user when a recipient clicks on the link included in the email. As shown in FIG. 3, when setting up a user's profile, computer system 100 can give a user an option to elect a default setting to always receive a notification when a recipient clicks on a link. This default notification can be overridden by a user when the user is sending an email from the “send to” screen.

### Tracking Viewing Data

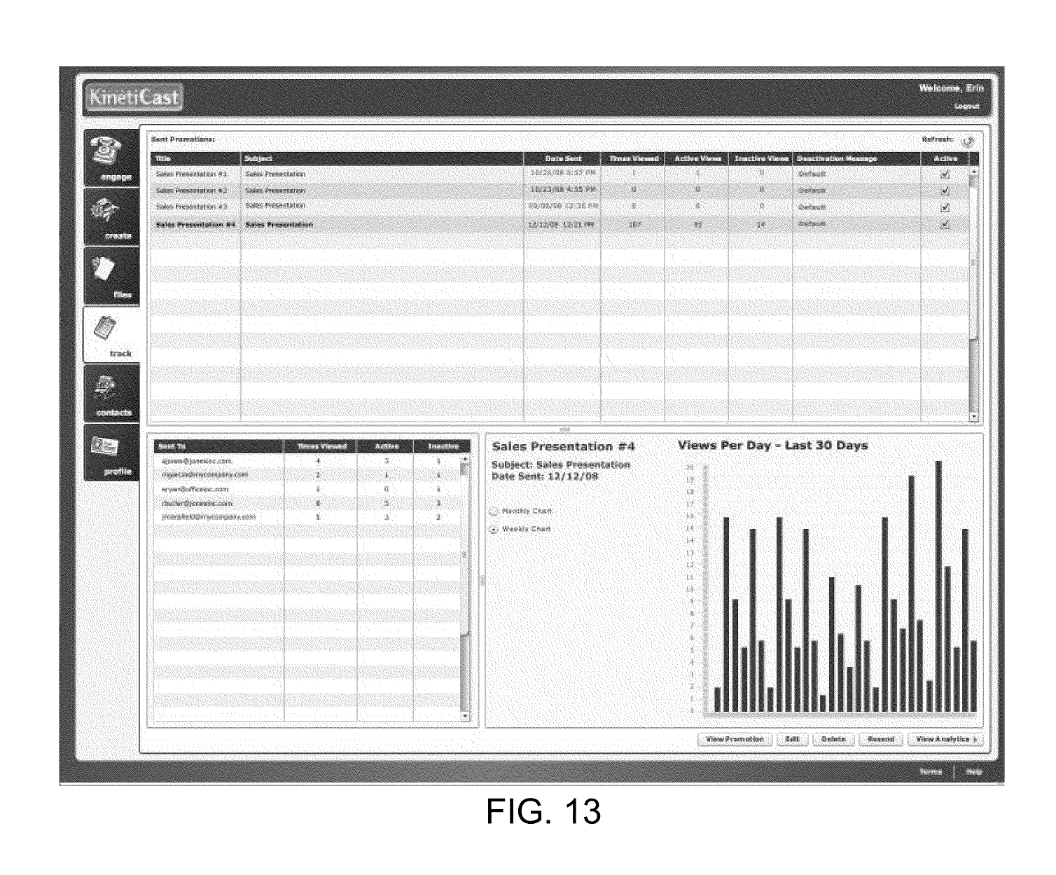

Computer system 100 allows a user to track or monitor the status of their sent RMP's and a recipient's viewing behavior. As shown in FIG. 13, this monitoring information can be displayed in the user's “Track” tab of the ODRMPT. A user is able to see whether a recipient has opened the RMP and how many times they have opened or viewed the RMP. It can also show whether a recipient has attempted to view the RMP after it has been deactivated. A user can also see how often an RMP is viewed over a time period, i.e., weekly or monthly. A user can also remove a RMP from “Track.”

An example of this tracking of an RMP is shown in FIG. 13. Tracking information is shown for an RMP titled “Sales Presentation” sent on Dec. 12, 2008. FIG. 13 shows that the presentation has been viewed a total of 107 times, with 93 active views and 14 inactive views. It also shows that the user's default message has been set as the deactivation message. FIG. 13 also shows, in the box on the lower left, the list of recipient's to which the RMP was sent. In the box on the lower right, a chart is shown illustrating on what days the RMP was viewed, either monthly or weekly.

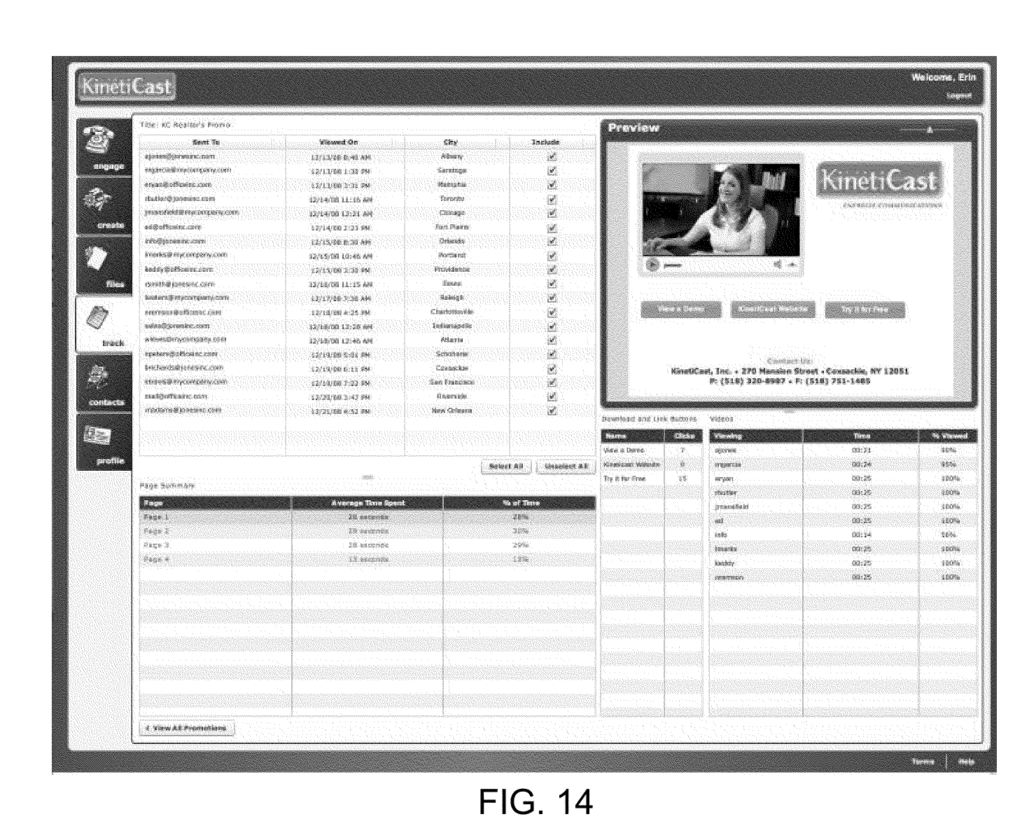

As shown in FIG. 14, a user can also track recipients' analytics, i.e., viewing behavior, with regard to the RMPs. For example, whether a recipient viewed every page of the RMP, how much time they spent viewing every page, whether they viewed a video in the RMP and if so, what percentage of the video they viewed, the IP Address of the computer, the company name of the recipient and the city that the RMP was accessed from, which can help a user assess whether or not the RMP was forwarded. The tracking functionality allows the user to track information individually for each recipient or as an aggregate for each RMP. For example, if a user sends the RMP to multiple recipients, the user can track each recipient's viewing behavior (i.e., how long did recipient 1 spend on page 3 of the RMP, did recipient 2 watch an entire video or download all the files associated with the download buttons/links), or can track the total viewing behavior for the RMP (i.e. which page was viewed the longest by the most recipients, how many times was each button/link clicked on, what was the average time spent on each page). In this way, a user can assess the impact of the RMP on the recipients, the effectiveness of each page, link, video, downloadable document, etc. For example, sales professionals may benefit from analytics about each individual potential customer's viewing of the RMP, whereas a marketing professional may be more interested in analytics about the RMP generally to assess the effectiveness of the marketing/message on a global level.

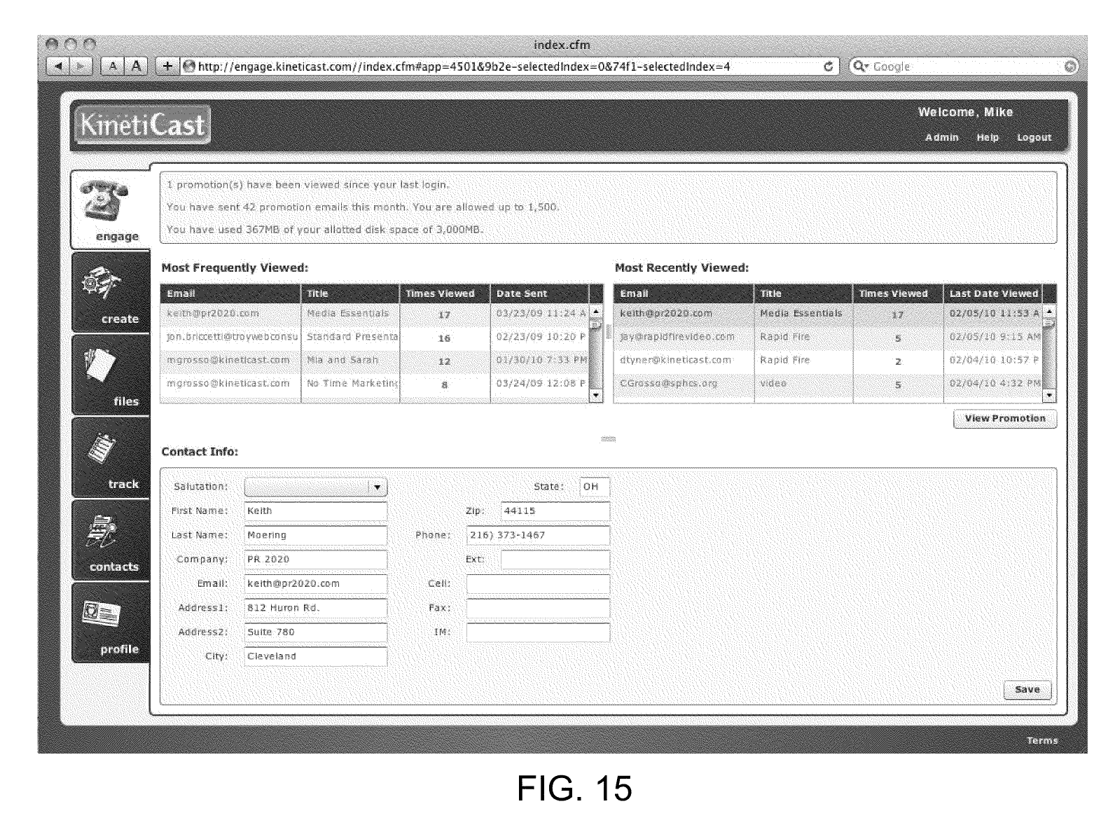

As shown in FIG. 15, under the “Engage” tab, computer system 100 allows a user to easily follow-up on sent presentations. For example, computer system 100 can provide the user with a summary of most frequently viewed RMPs and most recently viewed RMPs. Computer system 100 can further provide the user with contact information for each recipient for a chosen RMP to allow the user to easily contact the targeted recipient.

The present invention can be offered as a business method on a subscription or fee basis. For example, one or more components of the present invention can be created, maintained, supported, and/or deployed by a service provider that offers the functions described herein for customers. That is, a service provider can be used to provide the ODRMPT, as described above.

It should also be understood that the present invention can be realized in hardware, software, or a combination thereof. Any kind of computer/server system(s)—or other apparatus adapted for carrying out the methods described herein—is suitable. A typical combination of hardware and software can include a general purpose computer system with a computer program that, when loaded and executed, carries out the respective methods described herein. Alternatively, a specific use computer, containing specialized hardware for carrying out one or more of the functional tasks of the invention, can be utilized. The present invention can also be embedded in a computer program product, which comprises all the respective features enabling the implementation of the methods described herein, and which—when loaded in a computer system—is able to carry out these methods.

The invention can take the form of an entirely hardware embodiment, an entirely software embodiment, or an embodiment containing both hardware and software elements. The invention may be implemented in software, which includes but is not limited to firmware, resident software, microcode, etc.

The present invention can take the form of a computer program product accessible from a computer-usable or tangible medium providing program code for use by or in connection with a computer or any instruction execution system. For the purposes of this description, a computer-usable or tangible medium can be any apparatus that can contain, store, communicate, or transport the program for use by or in connection with the instruction execution system, apparatus, or device.

The medium can be an electronic, magnetic, optical, electromagnetic, infrared, or semiconductor system (or apparatus or device). Examples of a tangible medium include a semiconductor or solid state memory, magnetic tape, removable computer diskette, random access memory (RAM), read-only memory (ROM), rigid magnetic disk and optical disk. Current examples of optical disks include a compact disk-read only disk (CD-ROM), a compact disk-read/write disk (CD-R/W), and a digital versatile disk (DVD).

Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of various aspects of the disclosure has been presented for purposes of illustration and description. It is not intended to be exhaustive or to limit the disclosure to the precise form disclosed, and obviously, many modifications and variations are possible. Such modifications and variations that may be apparent to a person skilled in the art are intended to be included within the scope of the disclosure as defined by the accompanying claims.

I claim:

1. A method comprising:
providing a platform configured to allow a user to create a rich media presentation;
providing access to the rich media presentation to at least one recipient, distinct from the user; and
recording viewing behavior of the rich media presentation by the at least one recipient.

2. A computer system comprising:
a rich media presentation tool configured to implement a method, the method comprising:
providing a platform configured to allow a user to create a rich media presentation;
providing access to the rich media presentation to at least one recipient, distinct from the user; and
recording viewing behavior of the rich media presentation by the at least one recipient

3. A computer program comprising program code embodied in at least one computer-readable medium, which when executed, enables a computer system to implement a method of providing an online presentation tool, the method comprising:
providing a platform configured to allow a user to create a rich media presentation;
providing access to the rich media presentation to at least one recipient, distinct from the user; and
recording viewing behavior of the rich media presentation by the at least one recipient.
